(19) United States
(12) Patent Application Publication
(10) Pub. No.: US 2013/0120961 A1
(43) Pub. Date: May 16, 2013

(54) Beam Splitter Module For Illumination Systems

(71) Applicants: Chuan Wai Wong, Singapore (SG); Philip E. Watson, St. Paul, MN (US); Sheldon B. Ruiz, Singapore (SG)

(72) Inventors: Chuan Wai Wong, Singapore (SG); Philip E. Watson, St. Paul, MN (US); Sheldon B. Ruiz, Singapore (SG)

(73) Assignee: 3M INNOVATIVE PROPERTIES COMPANY, ST. PAUL, MN (US)

(21) Appl. No.: 13/810,755

(22) PCT Filed: Jul. 27, 2011
(86) PCT No.: PCT/US11/45456

§ 371 Date: Jan. 17, 2013

Related U.S. Application Data
(60) Provisional application No. 61/368,732, filed on Jul. 29, 2010.

(51) Int. Cl. F21V 9/14

(52) U.S. Cl. CPC F21V 9/14
USPC 362/19

(57) ABSTRACT

Beam splitter and illumination systems using beam splitters are described. Methods of providing a beam splitter with extended lifetime are also described.

### TECHNICAL FIELD

The present description relates to beam splitter modules and illumination systems utilizing such beam splitter modules. The present description further relates to methods of providing a beam splitter with an extended lifetime.

### BACKGROUND

Illumination systems incorporating polarizing beam splitters (PBSs) are used to form images on viewing screens, such as projection displays. A typical display image incorporates an illumination source that is arranged so that light rays from the illumination source reflect off of an image-forming device (i.e., an imager) that containers the desired image to be projected. The system folds the light rays such that the light rays from the illumination source and the light rays of the projected image share the same physical space between a PBS and the imager. The PBS separates the incoming light from the polarization-rotated image light.

### SUMMARY

In one aspect, the present description relates to an illumination system. The illumination system includes a light source that is capable of emitting light along a principal emission axis, a reflective polarizing film, and a means for laterally moving the reflective polarizing film in a direction orthogonal to the principal emission axis. The reflective polarizing film has a first major surface that receives light from the light source.

In another aspect, the present description relates to a method. The method includes a step of providing a light source capable of emitting light, where the light source having a principal emission axis. The method includes another step of positioning a reflective polarizing film on to a lateral movement element. The method finally includes a step of laterally moving the reflective polarizing film in a direction orthogonal to the principal emission axis using the lateral movement element.

In a third aspect, the present description relates to an illumination system. The illumination system includes a light source having a principal emission axis, a polarizing beam splitter, and a means for moving the beam splitter. The polarizing beam splitter receives light from the light source, and includes a reflective polarizing film. The means for moving the beam splitter moves it in a direction orthogonal to the principal emission axis of the light source.

In a final aspect, the present description relates to a polarizing beam splitter. The polarizing beam splitter includes a reflective polarizing film, a first cover, a second cover and a lateral movement device. The reflective polarizing film has a first major surface and a second major surface. The first cover is attached to the first major surface of the reflective polarizing film, and the second cover is attached to the second major surface of the reflective polarizing film. The lateral movement device is attached to the first cover or second cover, and it moves the polarizing beam splitter along a first axis, such that light incident upon the polarizing beam splitter is directly incident upon different portions of the film.

### BRIEF DESCRIPTION OF THE DRAWINGS

FIG. 1 is an isometric view of an illumination system according to the present description.

FIG. 2 is an isometric view of an illumination system according to the present description.

FIGS. 3a and b are an irradiance map and graph respectively for incident flux for a reflective polarizer according to the present description.

FIGS. 4a and b are irradiance graphs for incident flux for a reflective polarizer according to the present description.

FIG. 5 is an isometric view of an illumination system according to the present description.

FIG. 6 is a circuit for controlling movement of an illumination system according to the present description.

FIG. 7 is an isometric view of an illumination system according to the present description.

FIG. 8 is a side view of an illumination system according to the present description.

### DETAILED DESCRIPTION

Polarizing beam splitters are particularly important elements in certain illumination and projection systems. PBSs serve to separate illumination and image light in such systems, while providing for compact constructions. Prolonged exposure of the polarizing film in a PBS to incident light generally leads to degradation of the film, and consequently, a limited lifetime. Replacing a PBS in such a system can be tedious, time-consuming, and expensive. It would therefore be desirable to have an illumination system in which the reflective polarizing film of a PBS is capable of extended lifetime use without performance-limiting degradation. The present description provides for such a solution.

A number of materials used in PBSs tend to degrade over time. For example, certain polymeric reflective polarizing films become yellowish after long exposure to UV light. This “yellow degradation” affects both the color and transmittance of the film, and therefore limits the film's service life. Generally, however, the illumination beam from a light source in an illumination system is most directly incident on only a small surface area of the reflective polarizing film. Where an elongated film is provided, therefore, there often still exists a substantial amount of surface area of the film that is not degraded. The present description seeks to utilize a greater amount of surface area of the reflective polarizing film over time, thus extending the life of a PBS in an illumination system.

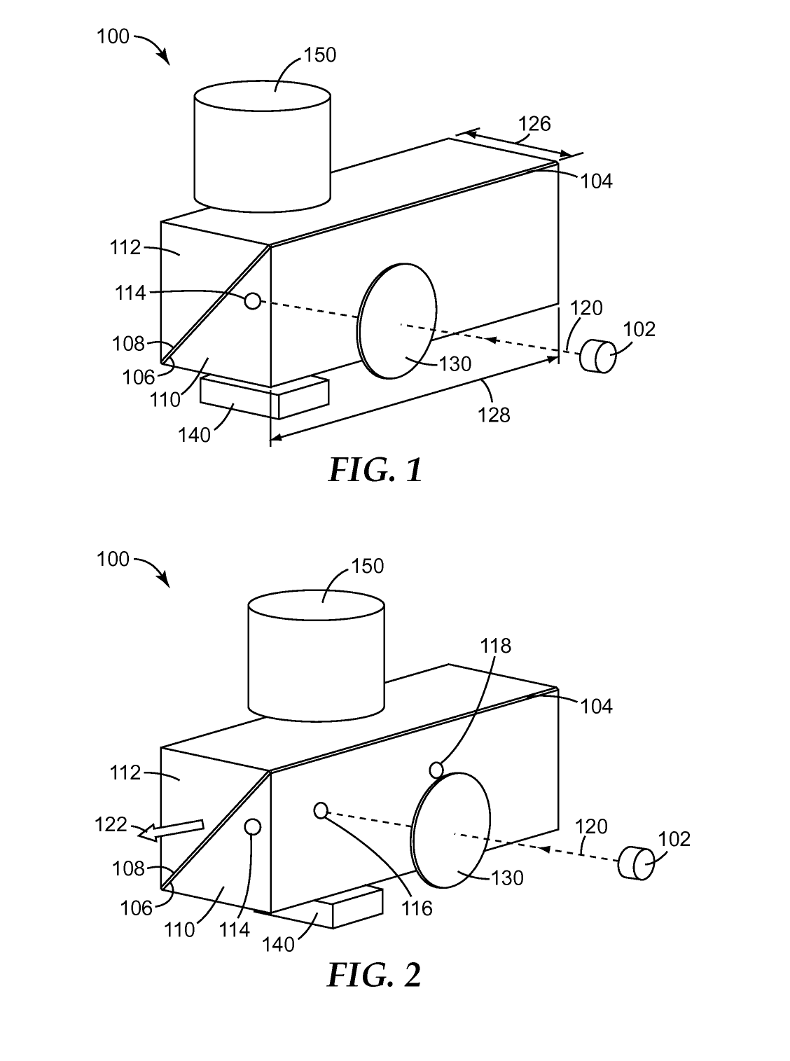

FIG. 1 illustrates one embodiment of an illumination system according to the present description. Illumination system 100 includes a light source 102. The light source 102 may be a solid-state light source, such as one or more light emitting diodes or laser light sources. The light source 102 emits light along a principal emission axis 120. The principal emission axis may be understood in some embodiments as the generalized direction of maximum luminosity of a light source. For example, where a light source is Lambertian, the principal emission axis 120 will have a spike of direct luminosity at a given direction/angle and a rapidly decreasing intensity of light in either angular direction.

This angle of most intense luminosity will be understood as the principal emission axis 120. It should be understood that the principal emission axis may not only be the generalized direction of maximum luminosity of a light source, but is also the generalized direction of maximum luminosity incident upon the PBS. Better understanding of this point may be gained by reference to FIG. 8. FIG. 8 displays the view of an illumination system from the side of the PBS. Therefore, for example, light from a light source 102 may be first reflected off of a 45 degree mirror 124 and then directed towards the reflective polarizing film 104. Here, the principal emission axis will be direction 120, the direction of maximum luminosity incident upon PBS 132. In this embodiment, PBS 132 includes reflective polarizing film 104, first cover 110, and second cover 112. The notion of the principal emission axis being the direction of maximum luminosity incident upon the PBS or reflective polarizing film holds true regardless of however many number of reflections or refractions may occur between the light source and the PBS/reflective polarizing film.

A particular element of illumination system 100 is reflective polarizing film 104. The reflective polarizing film may be any suitable sort of reflective polarizing film used as or for a polarizing beam splitter. The reflective polarizing film 104 includes a first major surface 106, and a second major surface 108. The first major surface 106 is the surface of the film that is positioned facing the light source 102, such that the film receives light from the light source 102 on the first major surface, along the principal emission axis 120. The second major surface 108 is positioned opposite the first major surface 106, such that it faces away from light source 102.

Examples of reflective polarizing films suitable for use as polarizing film 104 in the embodiments of the present disclosure include reflective polarizing films, such as birefringent, polymer films, e.g., multi-layer optical films (MOF) manufactured by 3M Corporation, St. Paul, Minn., such as those described in Jonza et al., U.S. Pat. No. 5,882,774; Weber et al., U.S. Pat. No. 6,609,795; and Magarill et al., U.S. Pat. No. 6,719,426, the disclosures of which are hereby incorporated by reference in their entirety. Suitable reflective polarizing films for polarizing film 104 also include polymeric reflective polarizing films that include multiple layers of different polymeric materials. For example, polarizing film 104 may include a first layer and a second layer, where the polymeric materials of the first and second layer are different and at least one of the first and second layers being birefringent. In one embodiment of the present disclosure, polarizing film 104 may include a multi-layer stack of first and second alternating layers of different polymer materials, as disclosed in Weber et al., U.S. Pat. No. 6,609,795. In another embodiment of the present disclosure, multiple reflective polarizing films may be used.

Suitable reflective polarizing films are typically characterized by a large refractive index difference between first and second polymeric materials along a first direction in the plane of the film and a small refractive index difference between first and second polymeric materials along a second direction in the plane of the film, orthogonal to the first direction. In some exemplary embodiments, reflective polarizing films are also characterized by a small refractive index difference between the first and second polymeric materials along the thickness direction of the film (e.g., between the first and second layers of different polymeric materials

The polymeric materials selected for the layers of an exemplary multilayer reflective polarizing film 104 may include materials that exhibit low levels of light absorption. For example, polyethylene terephthalate (PET) exhibits an absorption coefficient of less than 1.0×10⁻⁵ centimeter⁻¹. Accordingly, for reflective polarizer film that includes PET and has a thickness of about 125 micrometers, the calculated absorption is about 0.000023%, which is about 1/200,000 of an absorption of a comparable wire-grid polarizer.

Low absorptions are desirable because polarizers used in PBSs are exposed to very high light density, which can lead to the failure of the polarizers. For example, absorptive-type polarizer films absorb all the light with unwanted polarization. Heat will create degradation issues with a multilayer optical film even where absorption is more highly controlled, but high absorption generates significant heat and thus even shorter lifetimes. Substrates with high thermal conductivity, such as sapphire, are therefore needed to conduct the heat away from the polarizer films. Moreover, the substrates are exposed to high heat loads, which correspondingly generate thermal birefringence in the substrates. Thermal birefringence in the substrates degrades the contrast and contrast uniformity of the optical system, such as an image display system. As a result, only few materials can be qualified for the substrates with traditional PBSs (e.g., sapphire, quartz, leads content glass, and ceramics). Despite desirable material choices, degradation still occurs with the reflective polarizing film. Thus, the use of the solutions presented herein for laterally moving a PBS in conjunction with proper materials may result in vastly expanded lifetime.

In some embodiments, the reflective polarizing film 104 may be understood as generally “free-standing.” In other words, the film may be supported at its edges in some manner without being encased by other elements. With, or without a sort of encasing, the reflective polarizing film 104 should be understood as acting as a “polarizing beam splitter.” However, in a number of embodiments, such as shown in the illumination system 100 of FIG. 1, the film 104 may be encased. For example, disposed on the first major surface 106 of reflective polarizing film 104 may be a first cover 110. Disposed on the opposite side of the reflective polarizing film on second major surface 108 may be a second cover 112. When described as “disposed on,” it is to be understood that the first cover 110 and/or second cover 112 may be directly adhered to the reflective polarizing film, or may have a layer, or plurality of layers between itself and the reflective polarizing film. In one embodiment, the layer between at least one of the covers and the reflective polarizing film may be an air gap. This construction of a reflective polarizing film and two covers, or viewed another way, an “encased” reflective polarizing film, may also be understood as a PBS. Where the cover is adhered to the film, a suitable adhesive may include a pressure sensitive adhesive or a non-pressure sensitive adhesive (e.g., a thermally cured adhesive or a moisture cure adhesive). In some embodiments, the adhesive is a pressure sensitive adhesive. In some embodiments, the adhesive layer is a clear adhesive.

The first cover 110 and second cover 112 may be chosen from materials commonly used in PBSs. Generally, the cover material for either cover will be one that is transparent to light. In some cases, the cover material will also have a low birefringence. Often the covers will be prismatic, such that, e.g., the first cover has faces orthogonal to the principal emission axis 120 and also a face substantially orthogonal to an imager 140. One suitable choice for first cover 110 and second cover 112 is a glass prism. Ceramic and polymer, amongst other materials, may also be used for the cover composition. In at least some constructions, the PBS described, including at least the reflective polarizing film and potentially first and second covers, may be understood as a MacNeille polarizing beam splitter construction. MacNeille-type polarizing beam splitter constructions are further described in, e.g., E. Stupp and M Brennesholtz, “Reflective polarizer technology,” Projection Displays, 1999, pp. 129-133. However, in other embodiments, any number of other suitable polarizing beam splitters may be used.

Before light is incident upon reflective polarizing film 104 at first surface 106, and potentially also on first cover 110, it may first be incident upon illumination optics 130. Illumination optics 130 can act to condition the light from the light source 102 before it is incident upon the reflective polarizing film 104 to create desired characteristics. The optics 130 can change or alter one or more of the divergence of the light, the polarization state of the light, or the spectrum of the light. However, the optics 130 may generally be understood as not changing the principal emission axis 120. The illumination optics 130 may include, for example, one or more lenses, a color mixer, a light homogenizer, relay optics, a polarization converter, a pre-polarizer, and/or a filter to remove unwanted ultraviolet or infrared light.

Once light passes through optional illumination optics 130 it is incident upon the reflective polarizing film 104 at a first illumination position 114 located on the first major surface 106. This first illumination position 114 may be understood as where the reflective polarizing film 104 intersects with the principal emission axis 120 of the light source 102 (at a given time, as explained further). Light having a first polarization (e.g. p-polarized light) may be transmitted through the film 104, while light having a second polarization (e.g. s-polarized light) is reflected off of the film and directed towards the imager 140. The polarized light that is reflected off of the film 104 is unimaged illumination light. Light of the second polarization, after reflection off of reflection polarizing film 104 is then incident upon imager 140, where it is imaged and reflected, and the polarization is converted to the first polarization (e.g., from s-polarized light to p-polarized light). This “imaged” light of the first polarization returns from the imager 140 after reflection to the reflective polarizing film 104 and is allowed to transmit through the reflective polarizing film. The transmitted image light may next encounter projection optics 150. The projection optics 150 may include appropriate optical elements, such as, e.g., a projection lens or lenses. The design of such optics is typically optimized for each particular system, taking into account all of the components between the optics 150 and the imager 140. The projection optics 150 collect imaged light and direct it toward a display screen with the desired image.

The reflective polarizing film 104 however, degrades over time due to prolonged exposure to incident light from light source 102. Thus, an important problem to be solved is how to extend the lifetime of a PBS in an illumination system. The present description provides various techniques that enable exposure of different portions of the reflective polarizing film 104 to the principal emission axis 120 of light from the light source, such that direct exposure is spread to different portions of the film, and adequate performance may continue for an extended period of time. Specifically, the present description provides techniques for laterally moving the reflective polarizing film in a direction orthogonal to the principal emission axis.

FIG. 2, in conjunction with FIG. 1 illustrates the function of these techniques. Specifically, light may travel along principal emission axis 120 through illumination optics and be incident upon reflective polarizing film 104 at first illumination position 114, where principal emission axis 120 and reflective polarizing film 104 intersect. However, as shown in FIG. 2, the film 104 may be moved in a direction 122 that is orthogonal to principal emission axis 120; therefore, at “time 1,” reflective polarizing film 104 may intersect principal emission axis 120 at first illumination position 114. At a later “time 2,” reflective polarizing film 104 may intersect principal emission axis 120 at a second illumination position 116. At an even later “time 3,” the reflective polarizing film 104 may have been moved laterally once again, such that film 104 intersects principal emission axis 120 at third illumination position 118. The film may be moved to three or more different illumination positions (e.g., four, five, six or seven positions, etc.). By moving the reflective polarizing film while keeping the positions of items such as illumination optics 130, imager 140, and projection optics 150 static, the projected image is not disrupted, but different portions of the reflective polarizing film 104 are exposed.

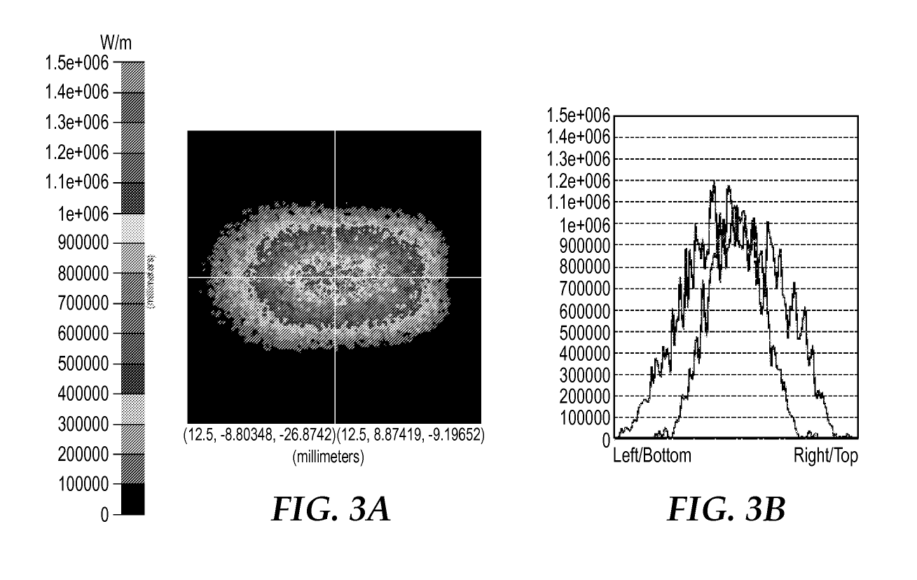

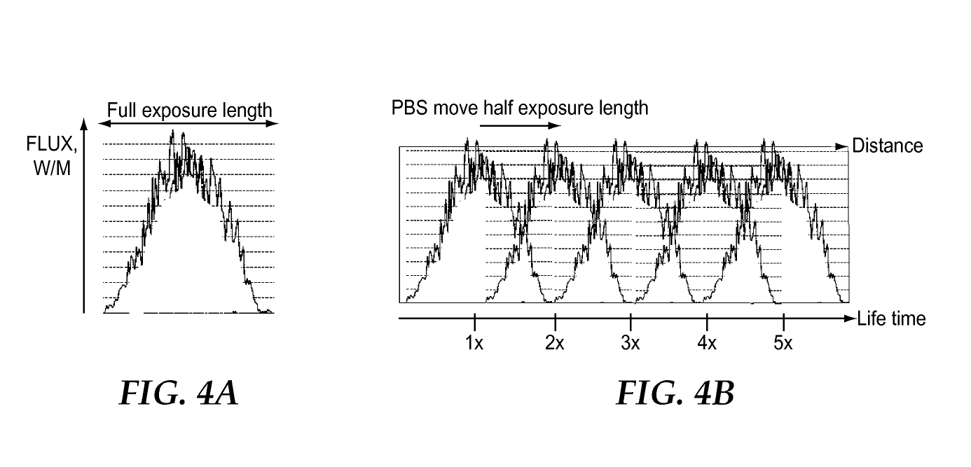

FIGS. 3a and 3b, for example, provide an irradiance map and accompanying graph of irradiance for incident flux for a reflective polarizing film of the type used in the current description. Aging life of a portion of the film may be understood as when a critical amount of light has been incident upon the portion of the film, such that it is degrading and light transmitted is yellowing. As is evidenced by the map and graph, half of the flux is contained within a third of the total exposure area from the center. Thus, when the center illuminated sub-portion of a film (which is centered at the principal emission axis intersection with the film) meets its aging life (critical amount of exposure), the surrounding area of the portion, which equates to two-thirds of the total exposure area, only reaches its half life. Based on this, the PBS can move only half the diameter of an exposure area, such that half of the light incident upon the film after the move is incident upon half of the initial exposure area. An irradiance graph of a given exposure level and area and the contemplated lateral move of the film are illustrated in FIGS. 4a and 4b. FIG. 4a again shows an irradiance graph for a reflective polarizing film according to the current description. In FIG. 4b a move of only half the diameter of an exposure area for this film is shown. After a move of half a diameter the new maximum luminosity receiving portion of the film (e.g., a second illumination position) corresponds to a point that received near zero luminance at the first illumination position. Portions that are off-peak luminosity similarly were off-peak in the first position, such that the summed flux at these points over both positions is at or near the maximum exposure limit. Therefore, as illustrated in FIG. 4b, a move of one-half the diameter of an exposure area results in two times the lifetime of the PBS. A second move of half the diameter of the exposure area results in three times the lifetime, a third move to four times the lifetime, and a fourth move to five times the lifetime, etc. Such a moderate incremental move may result in substantially all of the film being utilized to full illumination time capacity without degradation of the film.

Because of this ability to achieve increased lifetime by moving the reflective polarizing film laterally (orthogonal to the principal emission axis), it is also desirable to have enough lateral surface area to expose to the light source. Referring back to FIG. 1, in an embodiment where the reflective polarizing film 104 is covered by first cover 110 and second cover 112, one may define both a width 126 and length 128 of the first cover (and second cover—as the dimensions for the two covers of this embodiment are identical). As illustrated in FIG. 1, the first cover 110 has its width 126 in a direction parallel to the principal emission axis 120. The cover's length 128 is in a direction orthogonal to the principal emission axis, that is, the direction along which the reflective polarizing film 104 moves. To allow a greater surface area of a film to be exposed to the light source, thus allowing for greater lifetime, in some embodiments, it may be desirable for the length of the first cover to be greater than the width of the first cover, where the length of the reflective polarizing film is substantially the same length as the first cover.

Any suitable construction can be used to laterally move the reflective polarizing film in a direction orthogonal to the principal emission axis. The moving means may be something disposed on film 104 or on first or second covers 110 or 112, or on any element coupled to the film and/or covers through any number of appropriate means, e.g. adhesive, mechanically connecting/coupling, electromagnetic force, etc. Any suitable and appropriate force for connecting two structures is contemplated. In other embodiments, the moving means may actually be a portion of film 104, first cover 110, second cover 112, or part of an element proximate to such structural elements. The means for laterally moving the reflective polarizing film may be moved by any suitable force and medium. For instance, fuel-motorized system, pressured systems, spring-driven, and electrically-driven lateral moving elements are all contemplated, as well as any other sort of force capable of laterally driving the PBS. The PBS system may be laterally moved on a completely flat surface, or potentially on tracks, or potentially on wheels, or by an other appropriate means.

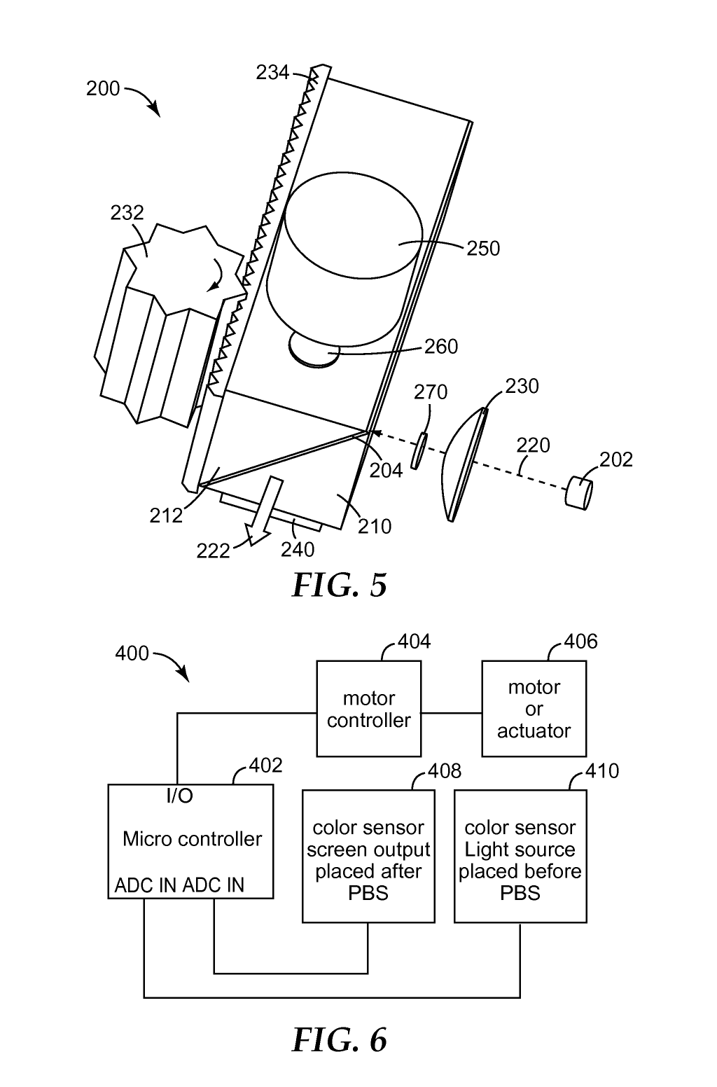

FIG. 5 illustrates an embodiment of one exemplary construction according to the present description. Illumination system 200 includes a light source 202 emitting light along a principal emission axis 220. It further includes illumination optics 230, imager 240 and projection optics 250. A reflective polarizing film 204 is placed between a first cover 210 and a second cover 212. In this system, the reflective polarizing film 204 is capable of being laterally moved in a direction 222 that is orthogonal to the principal emission axis 220. In this embodiment, the reflective polarizing film 204 is moved by a gear wheel 232. More specifically, the element 232 may be understood as a stepping motor gear. The stepping motor gear wheel is mechanically coupled to a plurality of gear teeth 234, where the gear teeth are attached to the second cover 212. When motor gear 232 is rotated, teeth 234 are moved laterally in direction 222, and film 204 is moved laterally as a consequence. Illumination system may also include color sensors 260 and 270.

The stepping motor gear 232 may be operated either manually or by automation. For example, a crank element may be attached to the gear 232 and may be used for manually moving the film 204 by turning the crank. In another embodiment, the gear motor may be wired to an automated system. The automated system may laterally move the reflective polarizing film 204 an incremental amount after a programmed period of time. In some systems, the automated system may move the reflective polarizing film based on a feedback reading.

For example, when a reflective polarizing film begins to degrade, the color of transmitted light becomes more yellow. The transmitted light color may be compared to the initial illumination light color to measure how much “yellowing” is occurring due to the reflective polarizing film 204. A color sensor 260 can be positioned to receive transmitted light and a preliminary color sensor 270 can be positioned to receive illumination light from the light source 202. The characteristics of the illumination light can then be compared to those of the transmitted light to detect when a particular portion of the film 204 is beginning to degrade. If the illumination system color levels are already known, a single color sensor 260 may be sufficient to detect film degradation. In some embodiments, the sensors 260 and 270 can be wired to motor 232 by a circuit, and the system may then laterally move the film in response to a high yellow reading. In other words, the system moves the film to a different illumination position when a given level of yellow light is detected. For example, FIG. 6 provides a schematic diagram of a circuit 400 that can provide this type of feedback. Sensors 260 and 270 should not be understood as solely limited to color sensors for detecting yellow light. In embodiments where the material type chosen for reflective polarizing film 204 does not become more yellow, but rather has lesser luminance, or a different coloring, for example, or any other sort of measurable change, sensors 260 and 270 may be constructed to measure such change.

As shown in FIG. 6, in one embodiment, a color sensor placed before the reflective polarizing film or PBS 410 as well as a color sensor placed after the reflective polarizing film or PBS 408 are each wired as inputs into a Micro controller 402. At a given differential in readings the micro controller may send a signal to the motor controller 404 wired in series to the micro controller. As noted, where the color levels of illumination light are known, a single sensor may be wired into the controller, where the controller is activated at a chosen signal level, rather than differential. This single level reading may be compared to a “ground” level of little to no yellowness, for example.

Upon a given yellowness reading, the motor controller may then activate a motor or actuator 406, causing the film 204 (of FIG. 5) to laterally move along direction 222, a direction orthogonal to principal emission axis 220 from a first illumination position to a second illumination, and from a second illumination position to a third illumination system, etc. As stated, the motor gear system in FIG. 5 may be moved in either an automated circuit system, such as that in FIG. 6, or may be moved manually using suitable techniques. In some situations, the film 204 may also be moved manually when a given color sensor reading alerts a human controller or operator to manually move film 204. Further, it should be understood that FIG. 6 offers only one example of an automated system. Any number of automated movement systems that may move in response to programmed time periods, or in response to a plurality of other sensory systems, are contemplated.

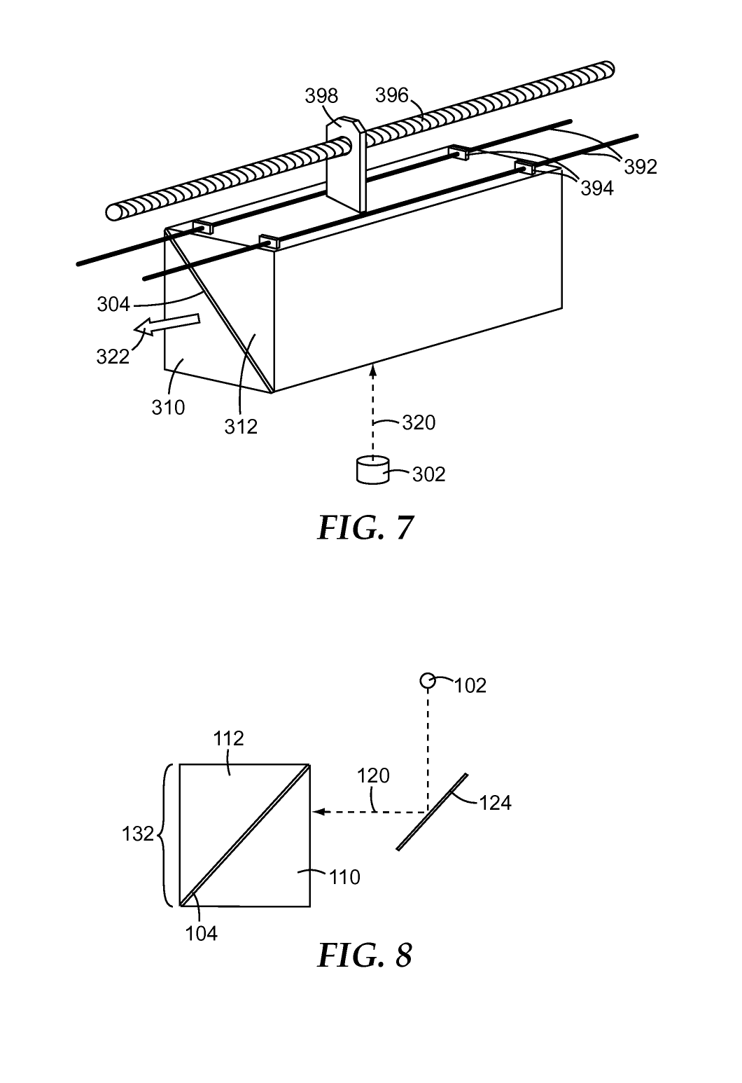

Another embodiment of a laterally movable reflective polarizing film/PBS is illustrated in FIG. 7. FIG. 7 includes a light source 302, and film 304 between first cover 310 and second cover 312. The embodiment also includes a lateral moving construction with linear shafts 392, connecting structures 394, second connecting structure 398, and screw shaft 396. This Figure provides for an embodiment in which a reflective polarizing film 304 acting as, or as a part of a PBS is attached to a moving construction. In the current embodiment, light from light source 302 again enters the PBS along principal emission axis 320 via a first cover 310 and is incident upon the film 304 at a first illumination location. Here, on the opposite side of the PBS from where light enters, attached to the second cover 312 is a screw shaft construction. Specifically, attached to the second cover via connecting structures 394 are linear shafts 392. These linear shafts serve as a guide for the reflective polarizing film 304 (or PBS) to move in a proper lateral direction 322 orthogonal to principal emission axis 320. The second cover is further attached by a second connecting structure type 398 to a screw shaft 396. Upon rotating the screw shaft 396, the film 304 is moved along the linear shafts 392 in lateral direction 322.

In some embodiments, the linear shafts 392 and screw shaft 396 will be on the same side of the reflective polarizing film 304 or on the same cover, e.g. the second cover 312. In other embodiments, both linear shafts 392 and screw shaft 396 will be on the opposite side of the reflective polarizing film 304 or on first cover 310. In some embodiments, linear shafts 392 will be on an opposite side of film 304 from shaft 396 or on opposite covers. Further, in some embodiments, there will only be linear shafts 392 or a screw shaft, but not both. In such a case, the linear shafts 392 may be made up of screw shafts that are adjustable, or the screw shaft 396 may both guide the film 304 and laterally move it. The screw shaft may be rotated manually by some sort of mechanical element such as a crank. Alternatively, the screw shaft may be controlled via automation and circuitry. Either mode of operation is contemplated, similar to the gear system described above. Also, the current embodiment may utilize color or other sensors to determine when the reflective polarizing film should be laterally shifted.

It should be understood that whether or not the lateral moving method or system is automated or manually operated, it may be repeatedly adjusted after a chosen period of time. In some embodiments, These periods can be approximately the same duration. The distance the film or PBS is moved can similarly be of equal distance—such that a first point of underexposure is reached without passing points of underexposure that go without use. Therefore, the film may be moved a chosen constant distance after a constant incremental period of time. This constant distance of shift is consistent with the shifts illustrated in FIG. 4b, for example, a shift of half the diameter of an exposure area.

Although described thus far as an article of manufacture, the content described herein, and figures provided thus far may also be understood as disclosing a method of providing a beam splitter or illumination system with extended lifetime. For example, looking the FIGS. 5 and 7, the method may be for providing a light source 202 capable of emitting light along a principal emission axis 220. The method may further involve positioning a reflective polarizing film 204 on to a lateral movement element, such as the gear system of teeth 234 coupled to gear wheel 232 or screw shaft 396 and linear shaft 392 system. The method may then further involve laterally moving the reflective polarizing film 204 in a direction 222 that is orthogonal to the principal emission axis 220 using the lateral movement element.

As noted with regard to FIGS. 1 and 2, the principal emission axis 120 may intersection the reflective polarizing film at a first illumination position 114 before laterally moving the film and at a second illumination position 116 after laterally moving the film. In fact the reflective polarizing film may be laterally moved to at least three different illumination positions, and potentially more. As noted with respect to the article embodiments disclosed, the method of positioning such a reflective polarizing film 104 may be accomplished by a manual positioning construction (such as the screw shaft system 392, 396 of FIG. 7) or automatically by an automated system. The method may further involve laterally moving the film a constant amount after a chosen incremental period of time or placing detectors that read light transmitted through the reflective polarizing film and laterally moving the reflective polarizing film at a given reading, e.g. when a given level of yellow light is detected. Further in the method described herein the reflective polarizing film may be positioned between a first transparent cover and a second transparent cover, where one of these covers is placed between the film and the lateral movement element.

In looking back at both of the illumination systems of FIGS. 5 and 7, the current invention may be understood from a different aspect as an illumination system that is primarily made up of a polarizing beam splitter and means for moving the polarizing beam splitter (where the beam splitter is made up of components 204, 210 and 212, or 304, 310 and 312). There, the reflective polarizing film is not the PBS itself, but a portion of the PBS. In either case, the element is still moved in a direction orthogonal to the principal emission axis of the light source. Similarly, the moving means may alternatively be understood as a “lateral movement” element or device that is simply part of a polarizing beam splitter, the polarizing beam splitter again containing a reflective polarizing film (204 or 304) and first and second covers (210, 310, and 212, 312). The polarizing beam splitter simply further is made up of a lateral movement device that is attached to the first cover or second cover and moves the PBS along a first axis, such that light incident upon the PBS is directly incident upon different portions of the film. The lateral movement device should not be understood as limited to the embodiments specifically disclosed herein. Rather, the lateral movement device may be made up of any sort of device capable of moving the PBS in the direction stated, and may be, for example, manually operated or automated.

The present invention should not be considered limited to the particular embodiments described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. An illumination system, comprising:
a light source, the light source capable of emitting light along a principal emission axis; and
a reflective polarizing film having a first major surface receiving light from the light source on the first major surface; and
a means for laterally moving the reflective polarizing film in a direction orthogonal to the principal emission axis.

2. The illumination system of claim 1, further comprising a first cover disposed on the first major surface, wherein the first cover has a width in the direction parallel to the principal emission axis, and a length in the direction orthogonal to the principal emission axis along which the reflective polarizing film moves, the length of the first cover being greater than the width.

3. (canceled)

4. The illumination system of claim 2, wherein the reflective polarizing film comprises a second major surface opposite the first major surface and further comprises a second cover, the a second cover being disposed on the second major surface.

5-6. (canceled)

7. The illumination system of claim 1, wherein the reflective polarizing film comprises a multilayer polymer film.

8-9. (canceled)

10. The illumination system of claim 1, wherein the reflective polarizing film is capable of intersecting the principal emission axis at a first illumination position at a first time, and the reflective polarizing film is capable of intersecting the principal emission axis at a second illumination position at a second time, the first illumination position being different than the second illumination position.

11. The illumination system of claim 10, the reflective polarizing film further comprising a third illumination position where the reflective polarizing film is capable of intersecting the principal emission axis at the third illumination position at a third time, the third time being different than the first and second illumination positions.

12. The illumination system of claim 1, wherein the means for laterally moving the reflective polarizing film is manually operated.

13. The illumination system of claim 1, wherein the means for laterally moving the reflective polarizing film is automated.

14. The illumination system of claim 13, further comprising a sensor for detecting color of light transmitted through the reflective polarizing film.

15. The illumination system of claim 13, wherein the automated means comprises a circuit and a motor.

16. The illumination system of claim 1, wherein the means for laterally moving the reflective polarizing film comprises a gear system.

17. The illumination system of claim 1, further comprising an imager that receives unimaged light from the reflective polarizing film, and reflects imaged light towards the reflective polarizing film.

18. (canceled)

19. The illumination system of claim 1, wherein the means for laterally moving the reflective polarizing film comprises a screw shaft system.

20. A method, comprising:
providing a light source capable of emitting light, the light source having a principal emission axis;
positioning a reflective polarizing film on to a lateral movement element; and
laterally moving the reflective polarizing film in a direction orthogonal to the principal emission axis using the lateral movement element.

21. The method of claim 20, wherein the principal emission axis intersects the reflective polarizing film at a first illumination position before laterally moving the film and a second illumination position after laterally moving the film.

22. The method of claim 20, wherein the reflective polarizing film is laterally moved to at least three different illumination positions.

23. The method of claim 20, wherein the laterally moving is performed using a manual positioning construction.

24. The method of claim 23, wherein the manual positioning construction comprises a screw shaft system.

25. The method of claim 20, wherein the laterally moving is performed automatically by an automated system.

26. (canceled)

27. The method of claim 20, further comprising detecting the color of light transmitted through the reflective polarizing film, and laterally moving the reflective polarizing film at a chosen sensor reading, the reflective polarizer laterally moving to a different illumination position when a given level of yellow light is detected.

28-29. (canceled)

30. The method of claim 20, wherein the lateral movement element comprises a gear system, the gear system comprises a gear wheel, and a plurality of gear teeth disposed on the reflective polarizing film.

31. An illumination system, comprising:
a light source having a principal emission axis;
a polarizing beam splitter that receives light from the light source, the polarizing beam splitter comprising a reflective polarizer film; and
a means for moving the beam splitter in a direction orthogonal to the principal emission axis of the light source.

32. (canceled)

33. The illumination system of claim 12, further comprising a means for detecting color of light transmitted through the reflective polarizing film.
